(19) United States
(12) Patent Application Publication
(10) Pub. No.: US 2026/0326219 A1
(43) Pub. Date: Oct. 22, 2026

(54) SKIVING TOOL AND SKIVING METHOD WITH SIMULTANEOUS ENGAGEMENT START OR ENGAGEMENT END OF TWO CUTTING EDGES

(71) Applicant: Reishauer AG, Wallisellen (CH)

(72) Inventors: Hartmut Marx, Wallisellen (CH); Philipp Michael Huber, Wallisellen (CH)

(73) Assignee: Reishauer AG, Wallisellen (CH)

(21) Appl. No.: 19/697,489

(22) Filed: Jun. 3, 2026

Related U.S. Application Data
(63) Continuation of application No. PCT/EP2024/083835, filed on Nov. 27, 2024.

(30) Foreign Application Priority Data
Dec. 8, 2023 (EP) 23215253.8

(51) Int. Cl. B23F 5/16; B23F 21/10

(52) U.S. Cl. CPC B23F 5/163; B23F 21/10

(57) ABSTRACT

Disclosed is a skiving of toothings where the machining of the tooth flanks of the toothing, cutting edge pairs of oppositely oriented cutting edges of a skiving tool each come simultaneously into contact and/or out of contact with two oppositely oriented tooth flanks of the toothing. Pushing-away effects and resulting machining inaccuracies can thereby be reduced. The two cutting edges of such a cutting edge pair are defined by different generating geometries. In particular, the two cutting edges of a cutting edge pair on the skiving tool do not extend in the same plane or on the same spherical surface.

### CROSS-REFERENCE TO RELATED APPLICATIONS

This continuation application claims priority to PCT/EP2024/083835 filed on Nov. 27, 2024 which published as WO 2025/119742 A1 and also European patent application number 23215253.8 filed on Dec. 8, 2023, the entire contents of which are fully incorporated herein with these references.

### DESCRIPTION

### Field of the Invention

The invention relates to a skiving tool for machining tooth flanks of a toothing of a workpiece, in that the skiving tool is rotated about a tool axis and the workpiece is rotated about a workpiece axis that extends skew to the tool axis, wherein the skiving tool and the workpiece are displaced relative to one another with a feed movement with a component along the workpiece axis, wherein the tool has a plurality of cutting teeth, each with a left and a right cutting edge, which cutting edges remove material from the tooth flanks facing each other at a tooth gap of the toothing when machining the workpiece. The invention further relates to a method for machining tooth flanks of a toothing of a workpiece by skiving, in that a skiving tool is brought into engagement with the toothing, wherein the skiving tool is rotated about a tool axis and the workpiece is rotated about a workpiece axis that extends skew to the tool axis, and wherein the skiving tool and the workpiece are displaced relative to one another with a feed movement comprising a component along the workpiece axis, wherein the tool has a plurality of cutting teeth, each having a left and a right cutting edge. Finally, the invention relates to a method for producing a skiving tool.

### Background of the Invention

Such skiving tools and skiving methods are known in principle, for example from EP 3 528 989 B1 or from EP 2 537 616 A1.

Various methods are known for producing toothed gears. Examples of machining processes include hobbing, planing, shaping or generating grinding. The so-called skiving process is a continuous machining process for machining toothed gears. Important skiving fundamentals and terms are explained, for example, in EP 3 528 989 B1. Skiving allows external toothed gears as well as internal toothed gears to be precisely produced.

In skiving, a skiving tool is rotated about a tool axis and a workpiece is rotated about a workpiece axis that extends skew to the tool axis. Simultaneously, a feed movement takes place, typically along the workpiece axis. The skiving tool has a plurality of cutting edges. Cutting teeth extend in an axial direction in straight-toothed skiving tools, or at a helix angle to the workpiece axis in helically toothed skiving tools. Rake faces are typically located on the end face of the cutting teeth of the skiving tool; in straight-toothed skiving tools, clearance faces extend approximately in the axial direction, or, in helically toothed skiving tools, clearance faces extend approximately at the helix angle to the workpiece axis on the cutting teeth.

In skiving, it is possible to machine both tooth flanks at a tooth gap of the toothing in the same pass (so-called double-flank skiving). For this purpose, the two cutting edges of one cutting tooth each engage with the tooth flanks facing each other at the corresponding tooth gap.

In the coupled rotary movement of the skiving tool and the workpiece, the cutting edges of known skiving tools engage and disengage individually one after the other with the toothing of the workpiece. The forces acting between the workpiece and the skiving tool change abruptly at the entry and exit points of the cutting edges. Due to the finite stiffness of the workpiece, the skiving tool and the skiving machine, the force changes lead to pushing-away effects. This often results in a local thickening (due to insufficient material removal) on the tooth flanks.

### SUMMARY OF THE INVENTION

### Object of the Invention

It is an object of the invention to improve the dimensional accuracy of toothings produced by skiving.

### Description of the Invention

This object is achieved according to the invention by a skiving tool in accordance with claim 1 and a skiving method in accordance with claim 7. Furthermore, this object is achieved by a method for producing a skiving tool in accordance with claim 14. Advantageous embodiments and variants are specified in each of the dependent claims and the description.

### Skiving Tool According to the Invention

According to the invention, a skiving tool is provided for machining tooth flanks of a toothing of a workpiece. For machining the tooth flanks, the skiving tool is rotated about a tool axis and the workpiece is rotated about a workpiece axis that extends skew to the tool axis, wherein the skiving tool and the workpiece are displaced relative to one another with a feed movement comprising a component along the workpiece axis. Due to axis kinematics, the feed movement also has a component along the tool axis. Typically, the feed movement occurs in parallel with the workpiece axis.

The skiving tool has a plurality of cutting teeth each with a left and a right cutting edge, which cutting edges remove material from the tooth flanks facing each other at a tooth gap of the toothing when machining the workpiece. The skiving tool is thus configured to machine both tooth flanks that define a tooth gap in one pass. In other words, the cutting teeth or their cutting edges are designed for double-flank skiving. The skiving tool can be straight-toothed or helically toothed.

The designation of the cutting edges as left and right cutting edges serves to distinguish the two cutting edges of a cutting tooth; one could also speak of first and second cutting edges. It is not of further importance which cutting edges are designated as left or right cutting edge. It is understood that the left and right cutting edges are located for all cutting teeth in each case in the same way on the cutting tooth. The same applies to the designation of the tooth flanks of the toothing to be machined as right or left tooth flanks.

According to the invention, it is provided that the left and right cutting edges of each of the cutting teeth extend on different spherical surfaces or in different planes. This allows the cutting edges to be adjusted so that a cutting-edge pair, consisting of a left and a right cutting edge, engages or disengages from the toothing of the workpiece simultaneously. In other words, when using the skiving tool, the left and right cutting edges of each cutting-edge pair advantageously come into contact and/or out of contact simultaneously with opposing tooth flanks, i.e., a left and a right tooth flank, of the toothing. The opposing (unlike) tooth flanks of the toothing point in opposite directions in the circumferential direction. Depending on the naming of the tooth flanks, the left cutting edges can each machine a left tooth flank and the right cutting edges can each machine a right tooth flank and simultaneously come into or out of contact with them. Alternatively, the left cutting edges can each machine a right tooth flank and the right cutting edges can each machine a left tooth flank, and simultaneously come into or out of contact with them.

The two cutting edges of each cutting-edge pair can be formed on the same cutting tooth. However, it is also conceivable that the two cutting edges of a corresponding cutting-edge pair are formed on different cutting teeth, in particular, on the nearest or next-nearest neighbors.

The geometry of the cutting edges corresponds to an intersection of the body conjugated to the toothing to be produced with a generating geometry of the corresponding cutting edge, wherein, according to the invention, different generating geometries cut the conjugated body for defining the left and right cutting edges. The generating geometry can be a spherical surface. In the special case of an infinite sphere radius, the spherical surface is a plane. For the left and right cutting edges, the intersection of, in particular, different spherical surfaces or planes with the conjugated body is calculated.

The conjugated body is the (imaginary) body which, in the axis configuration of the skiving process for which the skiving tool is intended, would roll on the toothing (to be produced) at every point when said tool rotates about the tool axis and when the workpiece rotates about the workpiece axis.

In skiving tools known from the prior art, the same generating geometry (often a plane or, in the case of a tool with a spherical grind, a sphere) is intersected with the conjugated body to define the two cutting edges of a cutting tooth. The rake face then is part of the generating geometry. The inventors recognized that, due to the kinematic conditions during skiving, this design of the tool leads to each cutting edge engaging or disengaging individually, resulting in the force fluctuations and shape deviations in the machined toothing explained at the outset.

According to the invention, two generating geometries per cutting tooth—one each for the right and left cutting edge—are used to design the skiving tool. The two cutting edges therefore do not lie in the same plane or on the same spherical surface, but rather each in a different plane or on a different spherical surface. A rake face of the skiving tool according to the invention is therefore not part of the plane or spherical surface of one of the cutting edges but mediates between the planes or spherical surfaces of the two cutting edges of a corresponding cutting tooth, possibly taking into account the height of rake face chamfers. Typically, the same two generating geometries are used for all cutting teeth of the skiving tool and are positioned identically relative to the corresponding cutting tooth (by rotating through one tooth pitch about the tool axis). In special cases, however, it is also conceivable that a plurality of pairs of generating geometries are used so as to define the cutting edges of a group of cutting teeth.

By the design according to the invention, the pushing-away effects explained at the outset during the entry or exit of the cutting edges on the toothing to be machined are avoided. This increases the dimensional accuracy of the produced toothing. Since—compared to the use of conventional skiving tools—there are lower force fluctuations between the workpiece and the skiving tool, the requirements for the drives or spindles for holding the workpiece and skiving tool are reduced. In particular, comparatively soft drives or spindles can be used without impairing the machining quality, which can lead to cost advantages. Conversely, when using the same skiving machine with the skiving tool according to the invention, the machining quality can be increased compared to a conventional skiving tool. By machining both the left and right tooth flanks of the toothing to be produced in a single machining pass, short cycle times are possible with high manufacturing quality.

Preferably, the skiving tool is used in a machining method according to the invention as described below. The scope of the present invention also includes the use of a skiving tool according to the invention, wherein the cutting edges of cutting-edge pairs, each formed by one of the left and one of the right cutting edges, come into contact and/or out of contact with opposing tooth flanks of the toothing simultaneously.

The skiving tool according to the invention can be obtained by a production method according to the invention described below.

An axis intersecting angle between the tool axis and the workpiece axis can be at least 5°, preferably at least 10°, and/or at most 45°, preferably at most 30°.

Preferably, a left rake face chamfer is formed between a rake face of each of the cutting teeth and its left cutting edge, and a right rake face chamfer is formed between the rake face of the respective cutting tooth and its right cutting edge. This allows a blunt blade to be obtained on both cutting edges, which can increase the service life of the skiving tool. Furthermore, a blunt blade can improve the machining quality. Blunt blades are suitable, in particular, for the hard fine machining of hardened workpieces.

The right and left rake face chamfers can be of different widths and/or inclined differently relative to the rake face. This allows for the same or at least approximately the same rake angles (which differ, for example, by at most 20°, preferably at most 10°) to be obtained for the chips running along the rake face chamfers on the right and left cutting edges.

A left clearance face chamfer can be formed between a left clearance face of each cutting tooth and its left cutting edge, and a right clearance face chamfer can be formed between the right clearance face of the corresponding cutting tooth and its right cutting edge.

Preferably, angles between the right and left rake face chamfers and the respective left and right clearance faces or—if present—respective left and right clearance face chamfers of the cutting teeth deviate by at most 30°, in particular, at most 15° from one another. In this way, the same cutting conditions can be achieved on both cutting edges, in particular, even if different wedge angles are formed between the left and right clearance faces and the rake face.

A rake face of each of the cutting teeth can extend in a rake face plane which extends at an angle, deviating from 90°, to a helix direction of the cutting teeth. In the case of a straight-toothed skiving tool, the “helix direction” of the cutting teeth is parallel to the tool axis. In this way, a step grind can be obtained, which simplifies the arrangement according to the invention of the two cutting edges of a cutting tooth on different generating geometries.

In particular, the angle between the rake face plane and the helix direction can deviate from 90° by at least 5°, preferably at least 10°, particularly preferably at least 20°. Such large deviations from the normal plane to the helix direction have proven advantageous in the inventors' investigations. In contrast, with conventional skiving tools, the rake face plane extends generally perpendicular to the helix direction of the cutting teeth.

### Machining Method According to the Invention

The scope of the invention also includes a method for machining tooth flanks of a toothing of a workpiece by skiving, in that a skiving tool is brought into engagement with the toothing, wherein the skiving tool is rotated about a tool axis and the workpiece is rotated about a workpiece axis that extends skew to the tool axis, and wherein the skiving tool and the workpiece are displaced relative to one another with a feed movement comprising a component along the workpiece axis. The skiving tool has a plurality of cutting teeth each with a left and a right cutting edge. The skiving tool is preferably a skiving tool according to the invention as described above. Due to axis kinematics, the feed movement also has a component along the tool axis. Typically, the feed movement occurs in parallel with the workpiece axis. The speed of the feed movement is typically constant. An axis intersecting angle between the tool axis and the workpiece axis can be at least 5°, preferably at least 10°, and/or at most 45°, preferably at most 30°. The toothing can be an internal toothing or an external toothing.

The machining method according to the invention is characterized in that the cutting edges of cutting-edge pairs, each formed by one of the right and one of the left cutting edges, come into contact and/or out of contact with opposing tooth flanks of the toothing simultaneously. In other words, the cutting edges of the skiving tool form pairs, each consisting of a left and a right cutting edge. For each cutting-edge pair, both cutting edges simultaneously come into and/or out of contact with the toothing of the workpiece. Preferably, each cutting edge of the skiving tool is part of such a cutting-edge pair. To define suitable left and right cutting edges of a corresponding cutting-edge pair, different generating geometries, in particular, different spherical surfaces or planes, can be intersected with the body conjugated to the toothing to be produced.

In the implementation according to the invention of the skiving method, the pushing-away effects explained at the outset during the entry and/or exit of the cutting edges on the toothing to be machined are avoided. This increases the dimensional accuracy of the produced toothing. Since—compared to the use of conventional skiving tools—there are lower force fluctuations between the workpiece and the skiving tool, the requirements for the drives or spindles for holding the workpiece and skiving tool are reduced. In particular, comparatively soft drives or spindles can be used without impairing the machining quality, which can lead to cost advantages. Conversely, when using the same skiving machine to carry out the machining method according to the invention, the machining quality can be increased compared to conventional skiving. By machining both the left and right tooth flanks of the toothing to be produced in a single machining pass, short cycle times are possible with high manufacturing quality.

The cutting edges on the skiving tool, which come into and/or out of contact simultaneously can be arranged directly adjacent to one another. The cutting edges of a cutting-edge pair are in this case each formed by two directly adjacent cutting edges. This can simplify the design of the skiving tool. This variant is suitable, in particular, for skiving tools with few cutting teeth and/or workpieces with few teeth. The two cutting edges, which simultaneously come into and/or out of contact, can be formed on the same cutting tooth in this case. Alternatively, the two cutting edges, which each come into and/or out of contact simultaneously, can be formed on directly adjacent cutting teeth with the cutting edges facing each other; in other words, the two cutting edges can be arranged at the same tooth gap of the skiving tool.

Alternatively, at least one left and at least one right cutting edge can be arranged between the cutting edges of a cutting-edge pair that simultaneously engage and/or disengage. In this variant, the cutting edges of one of the cutting-edge pairs are not direct neighbors. This variant is suitable, in particular, for skiving tools with many cutting teeth and/or workpieces with many teeth.

The simultaneously starting and/or ending engagement of the cutting edges of each of the cutting-edge pairs can occur with respect to various parameters. Preferably, the start and/or end of the engagement occur simultaneously with respect to a plurality of, in particular, all, of the parameters explained below.

The right and left cutting edges of a corresponding cutting-edge pair can come into contact and/or out of contact with the opposing tooth flanks when the workpiece and the skiving tool are in the same axial position in the feed direction. The same axial position is present, in particular, if the feed movement between the start or end of contact on the two opposing tooth flanks is less than 20 μm, preferably less than 10 μm, and particularly preferably less than 5 μm.

The right and left cutting edges of a corresponding cutting-edge pair can come into contact and/or out of contact with the opposing tooth flanks when the skiving tool is in the same rotational position with respect to the tool axis. The same rotational position is present, in particular, when a rotation angle of the rotary movement of the skiving tool about the tool axis between the start or end of contact on the two opposing tooth flanks is less than 0.5°, preferably less than 0.2°, particularly preferably less than 0.1°, and most preferably less than 0.05°.

The right and left cutting edges of a corresponding cutting-edge pair can come into contact and/or out of contact with the opposing tooth flanks at the same time. A contemporaneous start or end of contact occurs, in particular, if less than 60 μs, preferably less than 30 μs, particularly preferably less than 15 μs, and most preferably less than 7 μs, elapse between the start or end of contact on the two opposing tooth flanks.

The skiving process is preferably a hard fine machining process that is carried out after hardening the toothing. In hard fine machining, the improved dimensional accuracy according to the invention of the toothing is particularly important, since typically no further shape defining machining is carried out.

Typically, soft machining of the toothing is carried out before hardening. Soft machining can be carried out, for example, by hobbing, planing, shaping or, preferably, skiving. Soft machining can also be carried out using a machining method according to the invention and/or a skiving tool according to the invention. In this respect, the invention also relates to a production method comprising soft machining, hardening and hard fine machining, wherein soft machining and/or hard fine machining can be carried out using the method according to the invention.

In an alternative, advantageous method variant, the skiving process is a soft machining process, which is not followed by any further material-removing, in particular, no further chip-removing, machining of the tooth flanks. The shape of the tooth flanks generated during soft machining is thus obtained on the finished workpiece. In soft machining, the service life of the skiving tool can be increased compared to hard machining. Following soft machining, chemical, physical and/or thermal surface treatment, in particular, hardening, can be carried out. For example, the tooth flanks or the entire workpiece can be nitrided. In this respect, the invention also relates to a production method comprising a soft machining process carried out using the method according to the invention and a subsequent non-abrasive surface treatment, in particular, a hardening operation, of the tooth flanks, wherein the production method does not comprise any material-removing hard machining after the non-abrasive surface treatment. In this variant, a hardening process such as nitriding, is used in principle, which causes only slight distortion, and therefore corrective post-machining can be dispensed with.

The head sections of the cutting teeth can pass through the tooth gaps of the toothing without touching the workpiece. This method design is suitable, in particular, for hard fine machining. By allowing the head sections of the cutting teeth to pass through the tooth gaps without contact, pushing-away effects in the radial direction are reduced. This further improves the dimensional stability of the produced toothing.

### Production Method According to the Invention for a Skiving Tool

The scope of the present invention further includes a method for producing a skiving tool, comprising the steps of:
A) specifying a toothing to be produced with a workpiece axis;
B) specifying a position of a tool axis relative to the workpiece axis;
C) calculating a body with a plurality of teeth, which is conjugated to the toothing to be produced for the specified relative position of tool axis and workpiece axis, such that the conjugated body rolls with the toothing at every point when rotating about the tool axis and when the toothing rotates about the workpiece axis;
D) for each tooth, calculating an intersection of the conjugated body with two different generating geometries, such that the intersection lines of the conjugated body with the generating geometries define right and left cutting edges which in pairs simultaneously come into contact and/or out of contact with the toothing to be produced when the toothing is rotated about the workpiece axis and the conjugated body about the tool axis;
E) producing the skiving tool with the cutting edges determined in step D).

This production method can be used to obtain a skiving tool according to the invention, which allows the implementation of the machining method according to the invention.

Initially, the teeth of the conjugated body are typically not limited along the tool axis. The cutting edges (and a rake face arranged between the corresponding right and left cutting edges) form axial limits, so that for each tooth of the conjugated body a cutting tooth of the skiving tool is obtained.

In step D), the cutting edges of the cutting teeth are defined by the different generating geometries by intersecting the generating geometries with the conjugated body. The generating geometries can be spherical surfaces or planes. This simplifies the implementation of the method.

Generally, the two cutting edges of a cutting tooth are obtained by different generating geometries, which are not only rotated about the tool axis by a pitch angle between the teeth under consideration, but also have an additional variation, for example, being positioned differently along the tool axis and/or being inclined differently with respect to the tool axis and/or being of a different geometric type (e.g., one being a plane and the other a spherical surface).

A cutting edge pair that simultaneously engages and/or disengages can in each case be formed by the cutting edges of a single cutting tooth or of two different cutting teeth.

The fact that the engagement of the two cutting edges of a cutting-edge pair on the toothing ends and/or begins simultaneously can be ensured by numerical methods, for example CAD-supported, for example by varying the position and/or orientation of the generating geometries.

For example, a plane as the generating geometry can be displaced along the tool axis so as to define the left and right cutting edges of a cutting-edge pair. In the case of planes as the generating geometry, their inclination relative to the tool axis can alternatively or additionally be varied about one or two axes. Through numerical simulation of the skiving process, axial positions and/or inclinations of the planes can be identified at which the start and/or end of contact occur simultaneously.

In the case of spherical surfaces such as generating geometries, the center of the sphere can be displaced for the right and left cutting edges of a cutting-edge pair, preferably along the tool axis, alternatively or additionally also in one or two directions perpendicular thereto. Alternatively or additionally, the radius of the spherical surface can be changed. The center of the spherical surface is therefore not only rotated about the tool axis by a corresponding pitch angle, but an additional offset is also applied and/or the radius of the spherical surface is changed. Also, when using spherical surfaces, numerical simulation of the skiving process can be used to identify the different spherical surfaces for which the start and/or end of contact occurs simultaneously.

To define the two cutting edges of each of the cutting teeth, the two different generating geometries can each be rotated about the tool axis by the pitch angle of the cutting teeth of the skiving tool. The cutting teeth thus each obtain the same shape. Alternatively, it is conceivable to use a plurality of groups of two different generating geometries each so as to obtain groups of cutting-edge pairs on the skiving tool, wherein the cutting edges of different groups are contoured differently. This can further improve the surface quality of the toothing produced with the skiving tool.

After the production of the skiving tool, see step E), said tool can be used in a machining method according to the invention as described above.

Further features and advantages of the invention can be found in the claims, the description and the drawings. According to the invention, the aforementioned features and those which are to be explained below can each be used individually or as a plurality in expedient combinations of any kind. The embodiments shown and described are not to be understood as an exhaustive list, but, rather, have an exemplary character for the description of the invention.

### BRIEF DESCRIPTION OF THE DRAWINGS

FIG. 1 is a schematic view of skiving of a toothing with the relevant axes of movement;

FIG. 2 is a schematic view of the toothing in FIG. 1 and a body conjugated to the toothing;

FIG. 3 is a schematic perspective view of a skiving tool according to the prior art;

FIG. 4 is an enlarged schematic perspective view of a cutting tooth of a skiving tool;

FIG. 5 shows a schematic perspective view of a first embodiment of a skiving tool according to the invention;

FIG. 6 shows a cutting tooth of the skiving tool of FIG. 5, in an enlarged schematic perspective view;

FIG. 7.1 to 7.5 show the development of the contact relationships between tooth flanks of two adjacent teeth of a toothing of a workpiece, which tooth flanks face each other, and the two cutting edges of a cutting tooth, facing away from one another, of a skiving tool according to the invention during the skiving process according to the invention, in various schematic transverse sections with respect to the workpiece;

FIG. 8 shows a schematic perspective view of a second embodiment of a skiving tool according to the invention;

FIG. 9 shows a schematic longitudinal section through a cutting tooth of the skiving tool of FIG. 8;

FIG. 10 shows the course of the two cutting edges of a cutting tooth of the skiving tool of FIG. 8 with respect to a normal plane of the tool axis, in a schematic perspective view;

FIG. 11 shows a schematic flowchart of a method according to the invention for producing a skiving tool according to the invention;

FIG. 12 shows a flank line of a tooth of a toothing that was machined with a skiving tool according to the prior art;

FIG. 13 shows a flank line of a tooth of a toothing that was machined with a skiving tool according to the invention.

### DETAILED DESCRIPTION OF THE PREFERRED EMBODIMENTS

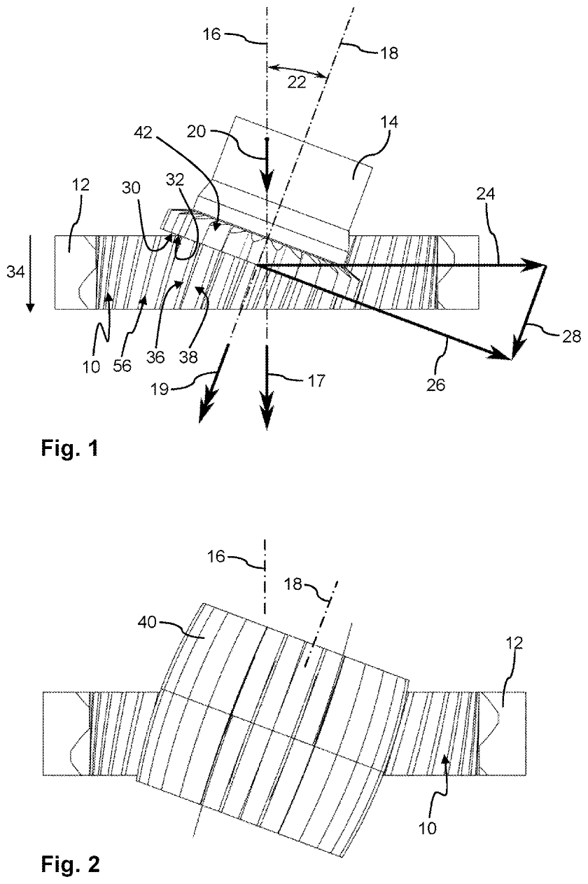

FIG. 1 shows a view of the kinematics of a skiving process for a toothing 10 of a workpiece 12 with a skiving tool 14. In this example, the workpiece 12 has internal teeth. Skiving a workpiece with external teeth is carried out in principle with the same movements. The kinematics shown in FIG. 1 applies equally to a skiving process known from the prior art as well as to skiving processes according to the invention that use skiving tools according to the invention.

For skiving, the toothed skiving tool 14 is brought into engagement with the toothing 10 to be machined. The workpiece 12 comprising the toothing 10 is rotated about a workpiece axis 16, as indicated by a double-headed arrow 17. At the same time, the skiving tool 14 is rotated about a tool axis 18, as indicated by a double-headed arrow 19. The rotational speeds are coordinated with one another. During the coupled rotary movement, a feed movement 20 is carried out, which typically extends along the workpiece axis 16.

The workpiece axis 16 and the tool axis 18 extend skew to one another. When projected onto a plane that is orthogonal to the common perpendicular of the axes 16, 18, an axis intersecting angle 22 is created, which can, for example, be between 10° and 30°. Typically, the axes 16, 18 extend in parallel with the plane that is orthogonal to the common perpendicular; however, the axes 16, 18 can optionally also be inclined toward or away from one another so that an angle of inclination is established (not shown in detail).

The circumferential speeds in the contact zone resulting from the rotational movements of the workpiece 12 and the skiving tool 14 are indicated by an arrow 24 for the workpiece 12 and an arrow 26 for the skiving tool 14. The vectorial difference of these circumferential speeds 24, 26 results in a cutting speed 28. The feed rate of the feed movement 20 is generally of no significance for the cutting speed. The feed movement 20 causes that as the left and right cutting edges 30, 32 successively engage, the machining process continues in the width direction 34 of the toothing, along the tooth flanks 36. When passing through a tooth gap of the toothing 10, the two cutting edges 30, 32 of a corresponding cutting tooth 42 remove material from the opposing tooth flanks 36, 38, which define the tooth gap.

During skiving, the toothing 10 can be machined from a workpiece without teeth. It is also possible to rework a pre-toothed workpiece 12 by skiving. Skiving can be carried out, in particular, after the workpiece 12 previously provided with teeth has been hardened.

To determine the shape of the cutting edges 40 of the skiving tool 14, reference can be made to the so-called conjugated body 40 of the toothing 10 to be produced; see FIG. 2. The conjugated body 34 is an imaginary body which is defined by the fact that in the axis configuration of the skiving process to be carried out, when said body rotates about the tool axis 18 and when the workpiece 12 rotates about the workpiece axis 16, it would roll at every point on the toothing 10 (to be produced). Based on the specification of the toothing to be produced and the axis configuration for the skiving process, the conjugated body can be calculated, for example using numerical methods. The cutting edges 40 can be defined as intersection lines of the conjugated body 34 with generating geometries, for example planes or spheres.

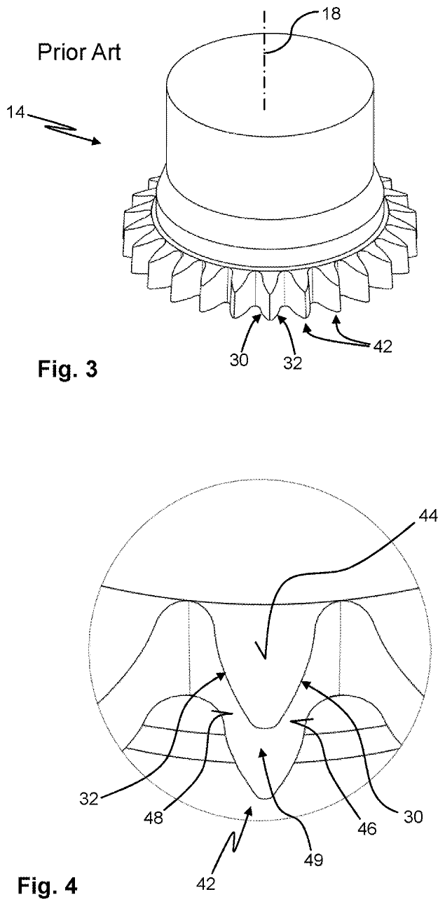

In skiving tools 14 from the prior art, the right and left cutting edges 30, 32 of a cutting tooth 42 are defined by the same generating geometry. In the case of a straight-toothed skiving tool 14, in the simplest way a single plane perpendicular to the tool axis 18 can be used as the generating geometry for the cutting edges 30, 32 of all cutting teeth 42. Such a skiving tool is shown in FIG. 3.

FIG. 4 shows an enlarged cutting tooth 42 of a skiving tool. The following explanations of the structure of the cutting tooth 36 apply equally to skiving tools according to the invention as well as to those known from the prior art.

A rake face 44 is formed on the end face of the cutting tooth 42. A left cutting edge 30 separates the rake face 44 from a left clearance face 46. During skiving, the cutting edge 30 removes material from left tooth flanks 36 of the toothing 10. A right cutting edge 32 is used for the machining of the right tooth flanks 38 that are opposite at a respective tooth gap of the toothing 10 (see FIG. 1). The right cutting edge 32 separates the rake face 44 from a right clearance face 48. A rake face chamfer can be arranged between the cutting edges 30, 32 and the rake face 44 (not shown in detail in FIG. 4). A clearance face chamfer can be arranged between the cutting edges 30, 32 and the corresponding clearance faces 46, 48 (not shown in detail in FIG. 4).

At the head 49 of the cutting tooth 36, typically no head cutting edge is formed in the present invention. Rather, the cutting tooth in the region of the head 50 is dimensioned in such a way that the head 49 does not come into contact with the tooth base of the toothing to be machined.

FIG. 5 shows a skiving tool 50 according to the invention for machining the toothing 10 of the workpiece 12 (see FIG. 1 in this respect). The skiving tool 50 is straight-toothed. Rake faces 44 of the cutting teeth 42 extend at an angle to the tool axis 18 that deviates from 90°. This creates a step grind.

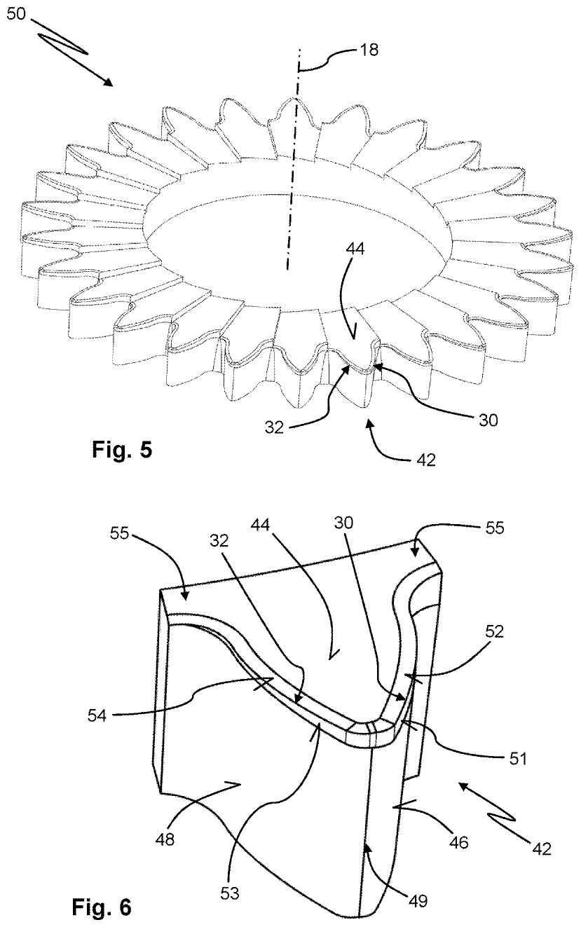

FIG. 6 shows a cutting tooth 42 of the skiving tool 50. A left cutting edge 30 (when viewed from the tool axis 18 over the rake face 44) extends in a first plane, which corresponds to the associated generating geometry when intersecting with the conjugated body 40 (see FIG. 2). A right cutting edge 32 extends in a second plane, which corresponds to the associated generating geometry when intersecting with the conjugated body 40. The planes of the two cutting edges 30, 32 are inclined to one another at a certain angle, for example between 0.5° and 5°. Points of intersection of the two planes with the tool axis 18 are therefore spaced apart from one another.

A left rake face chamfer 52 is arranged between the left cutting edge 30 and the rake face 44. A right rake face chamfer 54 is arranged between the right cutting edge 32 and the rake face 44.

Furthermore, a left clearance face chamfer 51 is arranged between the left cutting edge 30 and the left clearance face 46. A right clearance face chamfer 53 is arranged between the right cutting edge 32 and the right clearance face 48. In this case, the left clearance face chamfer 51 is wider than the right clearance face chamfer 53. The width of the right clearance face chamfer 53 increases from the foot 55 of the cutting tooth 42 towards its head 49. The width of the left clearance face chamfer 51 increases from the head 55 of the cutting tooth 42 towards the foot 55.

The course of the cutting edges 30, 32 on the cutting teeth 42 is chosen such that a left cutting edge 30 and a right cutting edge 32 simultaneously come into engagement with the toothing 10 of the workpiece 12 when machining said workpiece. Furthermore, the course of the cutting edges 30, 32 on the cutting teeth is chosen such that a left cutting edge 30 and a right cutting edge 32 simultaneously come out of engagement with the toothing 10 of the workpiece 12 when machining said workpiece. The start and end of contact occur simultaneously here in the sense that only a short period of time, for example at most 7 μs, elapses between the start or end of contact at one and the other cutting edge 30, 32. Accordingly, a rotation angle swept by the skiving tool 50 between the start or end of contact at one and the other cutting edge 30, 32 about the tool axis 18 can be negligibly small and amount to, for example, at most 0.07°. Furthermore, a feed path traveled by the skiving tool 50 between the start or end of contact at one and the other cutting edge 30, 32 relative to the workpiece 12 can be negligibly small and amount to, for example, at most 7.5 μm.

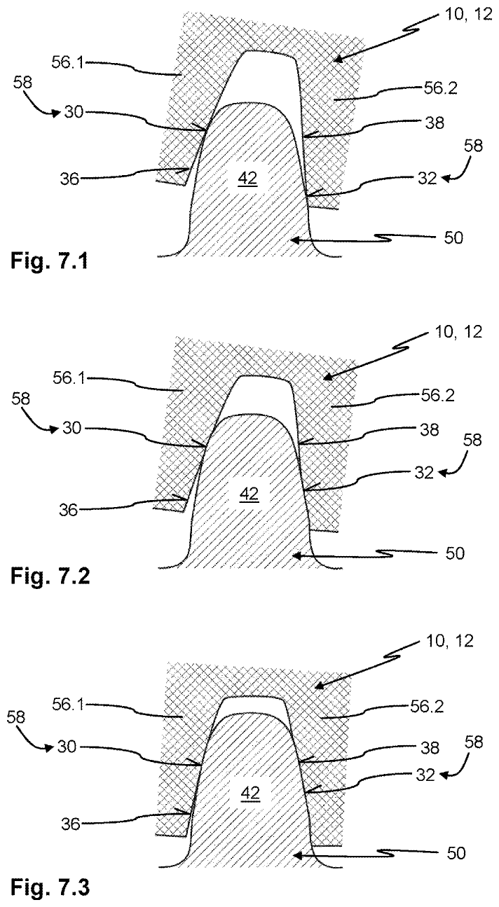

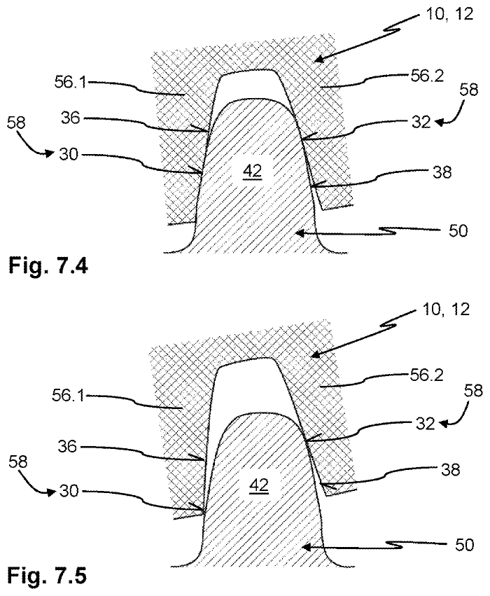

FIG. 7.1 illustrates by way of example how the left and right cutting edges 30, 32 of a cutting tooth 42 of a skiving tool 50 simultaneously come into engagement on directly adjacent teeth 56.1, 56.2 of the toothing 10 to be machined with their opposite tooth flanks 36, 38—in this case, the left tooth flank 36 of the tooth 56.1 and the right tooth flank 38 of the tooth 56.2. It should be noted that the cutting edges 30, 32 generally only extend locally, in the region of contact with the tooth flanks 36, 38 in the cutting plane of the transverse section with respect to the workpiece 12.

During the course of the machining, the contact between the skiving tool 50 and the toothing 10 progresses along the cutting edges 30, 32 and the tooth flanks 36, 38; see FIG. 7.2, 7.3 and 7.4.

Finally, the two cutting edges 30, 32 of the cutting tooth 42 simultaneously disengage from the right and left tooth flanks 36, 38 of the two teeth 56.1 and 56.2; see FIG. 7.5.

FIG. 7.1 to 7.5 are shown in the coordinate system of the skiving tool 50; the skiving tool 50 therefore appears stationary, although both the skiving tool 50 and the workpiece 12 rotate about the tool axis and workpiece axis, respectively.

During the course of the machining, this sequence is repeated for all tooth flanks 36, 38 facing each other on the directly adjacent teeth. In the described variant, the left and right cutting edges 30, 32 of one of the cutting teeth 42 each form a cutting-edge pair 58, which simultaneously comes into contact and out of contact with opposing tooth flanks 36, 38 of the toothing 10 to be machined.

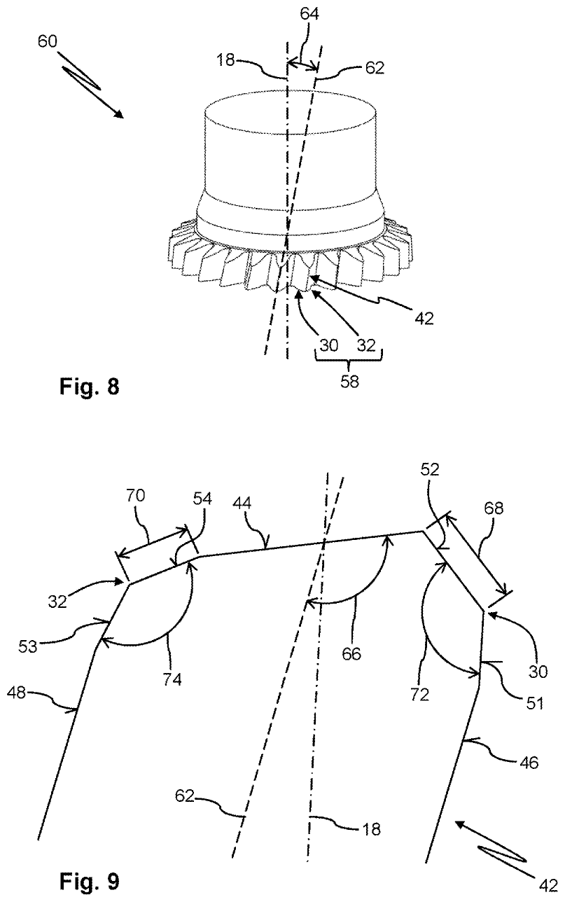

FIG. 8 shows a helically toothed skiving tool 60 according to the invention for machining the toothing 10 of the workpiece 12 (see FIG. 1 in this respect). Cutting teeth 42 of the skiving tool 60 each extend along a helix direction 62, which in radial projection onto the tool axis 18 forms an angle 64 with the tool axis 18 which can amount to, for example, at least 5° and at most 30°.

In the skiving tool 60, the two cutting edges 30, 32 of each of the cutting teeth 42 form a cutting-edge pair 58, which simultaneously engages and disengages with the tooth flanks 36, 38 of directly adjacent teeth 56 that are facing each other at a tooth gap of the toothing 10.

FIG. 9 shows a longitudinal section through one of the cutting teeth 42 of the skiving tool 60.

Left and right clearance faces 46, 48 extend parallel to the helix direction 62, since a kinematic free angle is established by the axis kinematics. Alternatively, the cutting tooth 42 could taper away from the cutting edges 30, 32 so as to increase the effective clearance angles.

In addition, clearance face chamfers 51, 53 are provided between the cutting edges 30, 32 and the clearance faces 46, 48.

A rake face 44 of the cutting tooth 42 extends in this case in a rake face plane that is not orthogonal to the helix direction 62. An angle 66 between the rake face 44 and the helix direction 62 can be, for example, 110°. Wedge angles between the rake face 44 and the two clearance faces 46, 48 therefore differ from one another. The workpiece axis 18 is also not oriented orthogonally to the rake face 44, but deviates by at least 5° from the rake face normal.

Between the rake face 44 and the two cutting edges 30, 32, rake face chamfers 52, 54 are arranged. In this case, a width 68 of the left rake face chamfer 52 is greater than a width 70 of the right rake face chamfer 54.

The two rake face chamfers 52, 54 are oriented such that angles 72, 74 measured between one of the clearance face chamfers 51, 53 and the adjacent rake face chamfer 52, 54 are approximately the same. Preferably, the angles 72, 74 differ from one another by at most 10°. If no clearance face chamfers 51, 53 are provided, the angles 72, 74 are measured between the rake face chamfers 52, 54 and the corresponding adjacent clearance face 46, 48 (not shown in detail).

In the course of the cutting edges 30, 32, the widths 68, 70 of the rake face chamfers 52, 54 and their corresponding inclinations to the rake face 44 can change, preferably maintaining same angles between the rake face chamfers 52, 54 and the corresponding adjacent clearance face chamfer 51, 53 (or, if no clearance face chamfers are formed, the corresponding adjacent clearance face 46, 48).

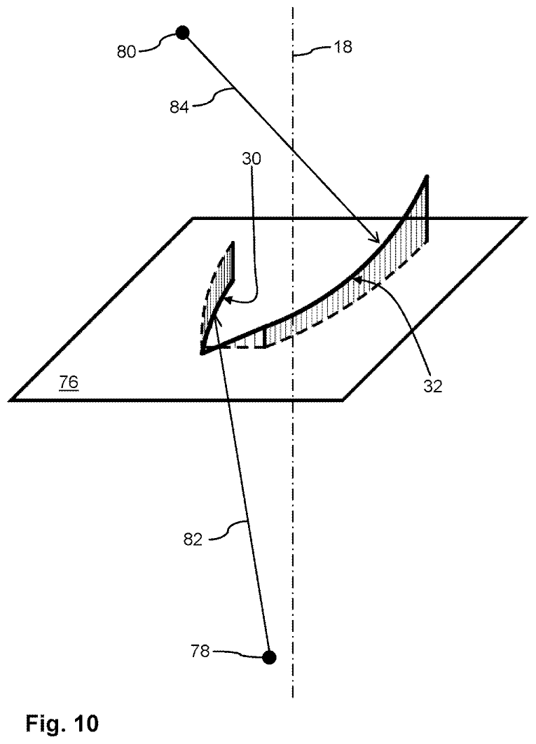

In the skiving tool 60, the two cutting edges 30, 32 lie on different spherical surfaces, which represent their corresponding generating geometry. This is illustrated in FIG. 10. In addition to the cutting edges 30, 32, their corresponding projection onto a plane 76 orthogonal to the tool axis 18 is shown as dashed lines, wherein it can be seen that the two cutting edges 30, 32 extend on different sides of the plane 76. Centers 78, 80 of the two spherical surfaces can lie on different sides of the plane 76, in particular, on the side on which the associated cutting edge 30, 32 lies. Furthermore, the centers 78, 80 can have different distances to the tool axis 18. Radii 82, 84 of the two spherical surfaces also differ from one another, for example by at least 10%.

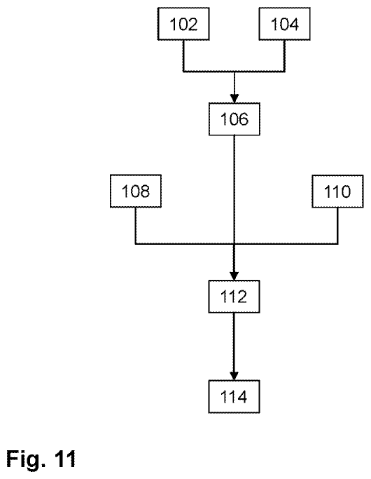

The sequence so as to obtain a skiving tool 50, 60 according to the invention is outlined in FIG. 11.

First, the geometry of a toothing 10 to be produced is specified; see step 102. In a step 104, the skiving kinematics, in particular, the position of a tool axis 18 relative to the workpiece axis 16, is specified. The number of cutting teeth 42 of the skiving tool 50, 60 to be manufactured can also be specified. In a step 106, the body 40 which is conjugated to the toothing to be produced is calculated from this information, so that the conjugated body rolls at every point of mutual contact with the toothing upon rotation about the tool axis and rotation of the toothing about the workpiece axis. A computer-aided method is typically used for this purpose.

In steps 108 and 110 the type of generating geometry can be specified for the left and right cutting edges 30, 32 of the skiving tool 50, 60 to be manufactured, for example whether they should lie in planes or on spherical surfaces. The generating geometries are parameterized appropriately. In a step 112, the two generating geometries are computationally intersected with the conjugated body 40, so that the cutting edges 30, 32 of the cutting teeth 42 are obtained. For this purpose, the generating geometries are rotated about the workpiece axis 18 according to the number of cutting teeth 42. The parameters of the generating geometries are varied in step 112 until the cutting edges 30, 32 dependent on these parameters come into and/or out of contact simultaneously in pairs with the tooth flanks 36, 38 to be produced when rolling on the toothing 10. A numerical optimization method can be used for this purpose.

In a step 114, at least one skiving tool 50, 60 is produced with the course of the cutting edges 30, 32 obtained from step 112.

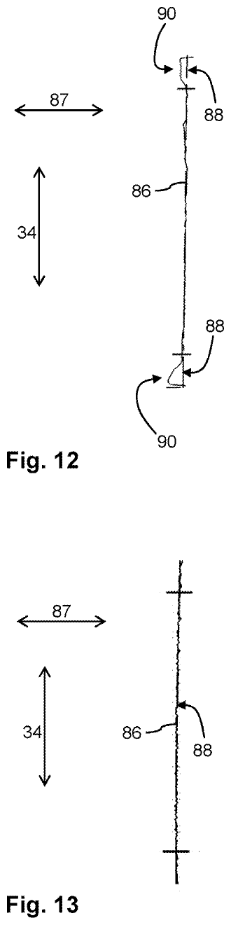

FIG. 12 shows the course of a flank line 86 of a tooth extending in the width direction 34 for a toothing produced with a skiving tool 14 known from the prior art with left and right cutting edges 42 lying in a common plane, i.e., a position measured in the circumferential direction 87 of the tooth flank is compared to a corresponding target position 88 (a larger scale is chosen in the circumferential direction than in the width direction). It can be seen that the flank line 86 deviates significantly from the target position 88, in particular, at its axial ends, in that local thickenings 90 are formed. This impairs the running behavior and durability of the toothing. The thickenings 90 result from the only one-sided engagement of one of the cutting edges 30 or 32, which leads to a deflection of the skiving tool and the workpiece relative to one another.

In FIG. 13 in contrast, a flank line 86 of a toothing is shown, which was produced with a skiving tool according to the invention, for example one of the skiving tools 50, 60, in a machining method according to the invention. It can be seen that the flank line 86 substantially extends in the target position 88. In particular, at the axial ends, but also in the middle region of flank line 86, neither thickenings nor depressions are visible. Due to the engagement of opposite cutting edges that is always in pairs, the components of the corresponding contact forces that cause the skiving tool and workpiece to be pushed away from one another are approximately canceled out, resulting in more precise machining. Only a slight, unavoidable waviness or roughness occurs in the flank line 86. With regard to running behavior and wear of the toothing, the course of the flank line 86 can be classified as very good.

In summary, the invention relates to the skiving of toothings. In the machining of the tooth flanks of the toothing, cutting edge pairs of oppositely oriented cutting edges of a skiving tool each come simultaneously into contact and/or out of contact with two oppositely oriented tooth flanks of the toothing. Pushing-away effects and resulting machining inaccuracies can thereby be reduced. The two cutting edges of such a cutting-edge pair are defined by different generating geometries. In particular, the two cutting edges of a cutting-edge pair on the skiving tool do not extend in the same plane or on the same spherical surface.

### LIST OF REFERENCE SIGNS

toothing 10
workpiece 12
skiving tool 14
workpiece axis 16
double-headed arrow 17
tool axis 18
double-headed arrow 19
feed movement 20
axis intersecting angle 22
circumferential speed 24 (for the workpiece 12)
circumferential speed 26 (for the skiving tool 14)
cutting speed 28
left cutting edge 30
right cutting edge 32
width direction 34
left tooth flank 36
right tooth flank 38
conjugated body 40
cutting tooth 42
rake face 44
left clearance face 46
right clearance face 48
head 49
skiving tool 50
left clearance face chamfer 51
left rake face chamfer 52
right clearance face chamfer 53
right rake face chamfer 54
foot 55
tooth 56; 56.1, 56.2
cutting edge pair 58
skiving tool 60
helix direction 62
angle 64 between tool axis 18 and helix direction 62
angle 66 between rake face 44 and helix direction 62
width 68 of the left rake face chamfer 52
width 70 of the right rake face chamfer 54
angle 72 between left clearance face chamfer 51 and left rake face chamfer 52
angle 74 between right clearance face chamfer 53 and right rake face chamfer 54
plane 76 orthogonal to the tool axis 18
center 78 of the spherical surface of the left cutting edge 30
center 80 of the spherical surface of the right cutting edge 32
radius 82 of the spherical surface of the left cutting edge 30
radius 84 of the spherical surface of the right cutting edge 32
flank lines 86
circumferential direction 87
target position 88
thickening 90
depression 92
specifying 102 a toothing 10 to be produced
specifying 104 skiving kinematics
calculating 106 the body 40 which is conjugated to the toothing 10
specifying 108 properties of a first generating geometry
specifying 110 properties of a second generating geometry
calculating 112 cutting edges 30, 32
producing 114 a skiving tool 50, 60

What is claimed is:

1. A skiving tool for machining tooth flanks of a toothing of a workpiece, wherein the skiving tool is rotated about a tool axis and the workpiece is rotated about a workpiece axis that extends skew to the tool axis, wherein the skiving tool and the workpiece are displaced relative to one another with a feed movement comprising a component along the workpiece axis,
wherein the skiving tool has a plurality of cutting teeth each with a left and a right cutting edge, which cutting edges remove material from tooth flanks facing each other at a tooth gap of the toothing when machining the workpiece,
wherein the left and right cutting edges of each of the cutting teeth extend on different spherical surfaces or in different planes.

2. The skiving tool according to claim 1, wherein a left rake face chamfer is formed between a rake face of each of the cutting teeth and its left cutting edge and wherein a right rake face chamfer is formed between the rake face of the respective cutting tooth and its right cutting edge.

3. The skiving tool according to claim 2, wherein the right and left rake face chamfers are of different widths and/or are inclined differently relative to the rake face.

4. The skiving tool according to claim 2, wherein angles between the right and left rake face chamfers and respective left and right clearance faces or respective left and right clearance face chamfers of the cutting teeth deviate by at most 30° from one another.

5. The skiving tool according to claim 2, wherein angles between the right and left rake face chamfers and respective left and right clearance faces or respective left and right clearance face chamfers of the cutting teeth deviate by at most 15° from one another.

6. The skiving tool according to claim 1, wherein a rake face of each of the cutting teeth extends in a rake face plane which extends at an angle, deviating from 90°, to a helix direction of the cutting teeth.

7. The skiving tool according to claim 6, wherein the angle between the rake face plane and the helix direction deviates from 90° by at least 5°.

8. The skiving tool according to claim 6, wherein the angle between the rake face plane and the helix direction deviates from 90° by at least 10°.

9. The skiving tool according to claim 6, wherein the angle between the rake face plane and the helix direction deviates from 90° by at least 20°.

10. A method for machining tooth flanks of a toothing of a workpiece by skiving, wherein a skiving tool is brought into engagement with the toothing,
wherein the skiving tool is rotated about a tool axis and the workpiece is rotated about a workpiece axis which extends skew to the tool axis,
and wherein the skiving tool and the workpiece are displaced relative to one another with a feed movement comprising a component along the workpiece axis,
wherein the skiving tool has a plurality of cutting teeth each with a left and a right cutting edge,
wherein the cutting edges of cutting-edge pairs, each formed by one of the right and one of the left cutting edges, come into contact and/or out of contact with opposing tooth flanks of the toothing simultaneously.

11. The method according to claim 10, wherein the cutting edges on the skiving tool, which come into and/or out of contact simultaneously are arranged directly adjacent to one another.

12. The method according to claim 10, wherein the right and left cutting edges of a corresponding cutting-edge pair come into contact and/or out of contact with the opposing tooth flanks when the workpiece and the skiving tool are in the same axial position in the feed direction.

13. The method according to claim 10, wherein the right and left cutting edges of a corresponding cutting-edge pair come into contact and/or out of contact with the opposing tooth flanks when the skiving tool is in the same rotational position with respect to the tool axis.

14. The method according to claim 10, wherein the right and left cutting edges of a corresponding cutting-edge pair come into contact and/or out of contact with the opposing tooth flanks at the same time.

15. The method according to claim 10, wherein the skiving is a hard fine machining process that is carried out after hardening the toothing.

16. The method according to claim 10, wherein head sections of the cutting teeth pass through the tooth gaps of the toothing without touching the workpiece.

17. The method according to claim 10, wherein the skiving tool has the plurality of cutting teeth each with the left and the right cutting edge, which cutting edges remove material from tooth flanks facing each other at a tooth gap of the toothing when machining the workpiece, wherein the left and right cutting edges of each of the cutting teeth extend on different spherical surfaces or in different planes.

18. A method for producing a skiving tool comprising the following steps:
A) specifying a toothing to be produced with a workpiece axis;
B) specifying a position of a tool axis relative to the workpiece axis;
C) calculating a body with a plurality of teeth, which is conjugated to the toothing to be produced for the specified relative position of tool axis and workpiece axis, wherein the conjugated body rolls with the toothing at every point when rotating about the tool axis and when the toothing rotates about the workpiece axis;
D) for each tooth, calculating an intersection of the conjugated body with two different generating geometries, wherein the intersection lines of the conjugated body with the generating geometries define right and left cutting edges which in pairs simultaneously come into contact and/or out of contact with the toothing to be produced when the toothing is rotated about the workpiece axis and the conjugated body is rotated about the tool axis; and
E) producing the skiving tool with the cutting edges determined in step D).

19. The method according to claim 18, wherein the generating geometries are spherical surfaces or planes.
